(19) United States
(12) Patent Application Publication
(10) Pub. No.: US 2026/0136195 A1
(43) Pub. Date: May 14, 2026

(54) PREVENTION OF BRUTE FORCE ATTACKS ON VOICEMAIL ACCOUNTS

(71) Applicant: T-Mobile USA, Inc., Bellevue, WA (US)

(72) Inventors: Geoffrey Todd Gibson, Ben Wheeler, TX (US); Jeffrey Scott Simon, Bellevue, WA (US); Tony Hoorn, Bunker Hill, WV (US)

(21) Appl. No.: 18/946,748

(22) Filed: Nov. 13, 2024

(51) Int. Cl. H04W 12/122; H04M 3/533; H04W 4/14; H04W 12/72

(52) U.S. Cl. CPC H04W 12/122; H04M 3/533; H04W 4/14; H04W 12/72

(57) ABSTRACT

A voicemail server device receives a voice call from an originating device attempting to access a voicemail account associated with a subscriber of a network service provider. Accessing the voicemail account can require providing by the originating device a personal identification number (PIN) predefined for the voicemail account. The voicemail server device can determine whether the originating device is associated with the subscriber. Responsive to determining that the originating device is not associated with the subscriber, the voicemail server device can activate an attempt limit for the voicemail account. The attempt limit can correspond to a predefined number of failed attempts to access the voicemail account by providing an incorrect PIN. The voicemail server device can receive attempts to access the voicemail account by incorrect PINs. Responsive to determining that a number of the attempts has reached the attempt limit, the voicemail server device can redefine the PIN.

### BACKGROUND

Voicemail accounts have become a critical component of modern communication systems. Voicemails can be susceptible to brute force cyberattacks. In a brute force attack, malicious actors systematically attempt all possible combinations of passwords or PINs to gain unauthorized access to voicemail systems. These attacks often exploit weak or default passwords, leveraging automated tools to perform rapid and exhaustive trial-and-error attempts. Once access is gained, attackers can intercept sensitive messages, manipulate voicemail settings, and use the compromised accounts for further fraudulent activities. The risks associated with such attacks are significant, including the potential for identity theft, financial loss, and unauthorized dissemination of confidential information.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 is a block diagram that illustrates a system for preventing brute force attacks on voicemail accounts.

FIG. 4 is a flow diagram that illustrates processes for preventing brute force attacks on voicemail accounts.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for methods and systems for preventing unauthorized access to voicemail accounts, including the prevention of brute force attacks. The disclosed system is configured to detect and identify suspect unauthorized attempts to access voicemail accounts and prevent such attempts from succeeding. In particular, the disclosed system prevents brute force attacks including repeated, systematic attempts to enter an access code (e.g., a personal identification number (PIN)) by activating an attempt limit on an account in response to detecting that the attempted voice calls are from devices not associated with the user associated with the voicemail account. When the attempt limit on failed attempts has been met, the system automatically redefines the access code associated with the voicemail account and notifies the user (e.g., by a text message or email).

The system is configured to effectively detect and prevent unauthorized access while avoiding unnecessary disruption to the user of the voicemail account. For example, in an instance that the failed attempts are originating from a phone number associated with the voicemail account, the system forgoes redefining the access code regardless of how many failed attempts are received. Further, the system can use behavioral analytical data (e.g., including historical geographical locations) to predict the likelihood that the attempts are by the subscriber. If the likelihood is above a threshold likelihood, the system can forgo redefining the access code.

In one example, a method for preventing unauthorized access to a voicemail account associated with a telecommunications network service provider includes receiving a voice call attempting to access a voicemail account by a voicemail server device associated with the network service provider. The voicemail account can be associated with a subscriber of the network service provider. The voice call can be originated from an originating device associated with an originating mobile station international subscriber directory number (MSISDN). Accessing the voicemail account can require providing a PIN predefined for the voicemail account by the originating device. The voicemail server device can determine whether the originating device is associated with the subscriber by determining whether the originating MSISDN corresponds to an MSISDN associated with the subscriber’s device. Responsive to determining that the originating device is not associated with the subscriber, the voicemail server device can automatically activate an attempt limit for the voicemail account. The attempt limit can correspond to a predefined number of failed attempts to access the voicemail account by providing an incorrect PIN. The voicemail server device can receive from the originating device during the voice call an incorrect PIN that is different from the PIN predefined for the voicemail account. The voicemail server device can receive additional attempts to access the voicemail account by incorrect PINs. The voicemail server device can automatically redefine the PIN and provide an indication of the redefined PIN to the subscriber responsive to determining that a number of the additional attempts has reached the attempt limit.

In another example, a non-transitory, computer-readable storage medium includes instructions which, when executed by at least one data processor of a voicemail server device associated with a network service provider, cause the voicemail server device to receive a voice call from an originating device attempting to access a voicemail account associated with a subscriber of the network service provider. Accessing the voicemail account can require providing by the originating device a PIN predefined for the voicemail account. The voicemail server device can be caused to determine whether the originating device is an on-network device associated with the network service provider. Responsive to determining that the originating device is not associated with the network service provider, the voicemail server device can be caused to activate an attempt limit for the voicemail account. The attempt limit can correspond to a predefined number of failed attempts to access the voicemail account by providing an incorrect PIN. The voicemail server device can be caused to receive attempts to access the voicemail account by incorrect PINs. Responsive to determining that a number of the attempts has reached the attempt limit, the voicemail server device can be caused to redefine the PIN.

In yet another example, a voicemail server device associated with a telecommunications network service provider includes at least one hardware processor and at least one non-transitory memory storing instructions, which, when executed by the at least one hardware processor, cause the voicemail server device to receive a voice call from an originating device attempting to access a voicemail account associated with a subscriber of the network service provider. Accessing the voicemail account can require providing by the originating device a PIN predefined for the voicemail account. The voicemail server device can be caused to determine whether the originating device is associated with the subscriber. Responsive to determining that the originating device is not associated with the subscriber, the voicemail server device can be caused to activate an attempt limit for the voicemail account. The attempt limit can correspond to a predefined number of failed attempts to access the voicemail account by providing an incorrect PIN. The voicemail server device can be caused to receive attempts to access the voicemail account by incorrect PINs. Responsive to determining that a number of the attempts has reached the attempt limit, the voicemail server device can be caused to redefine the PIN.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

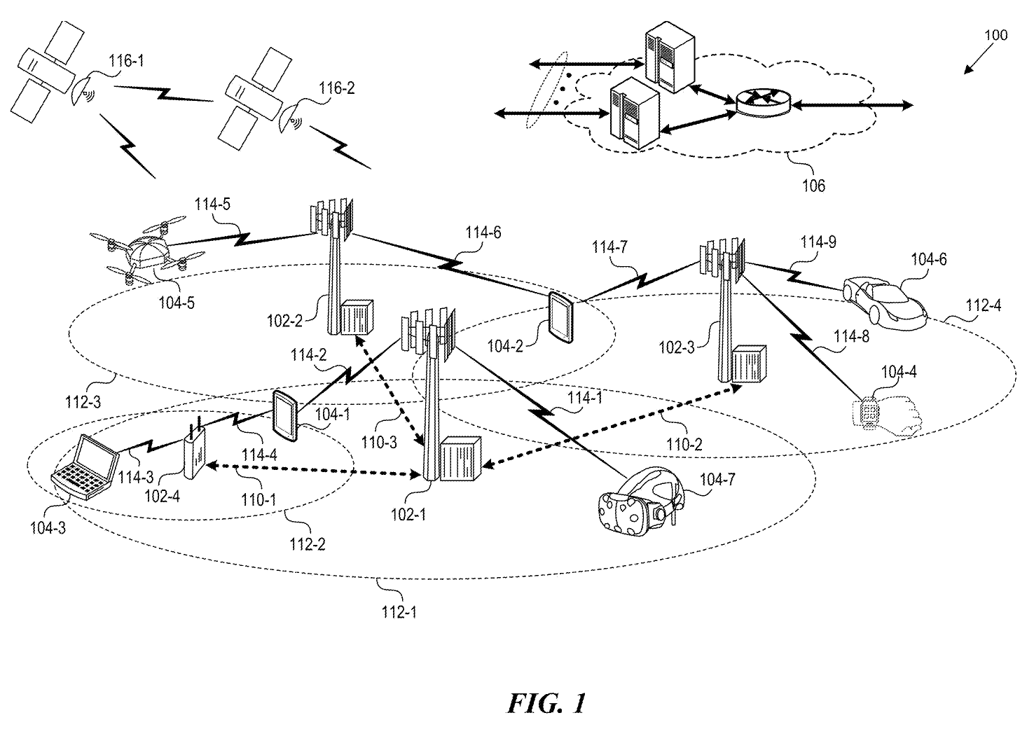

FIG. 1 is a block diagram that illustrates a wireless telecommunications network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the system 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a customer premise equipment (CPE), a mobile station, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or Time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh- definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### 5G Core Network Functions

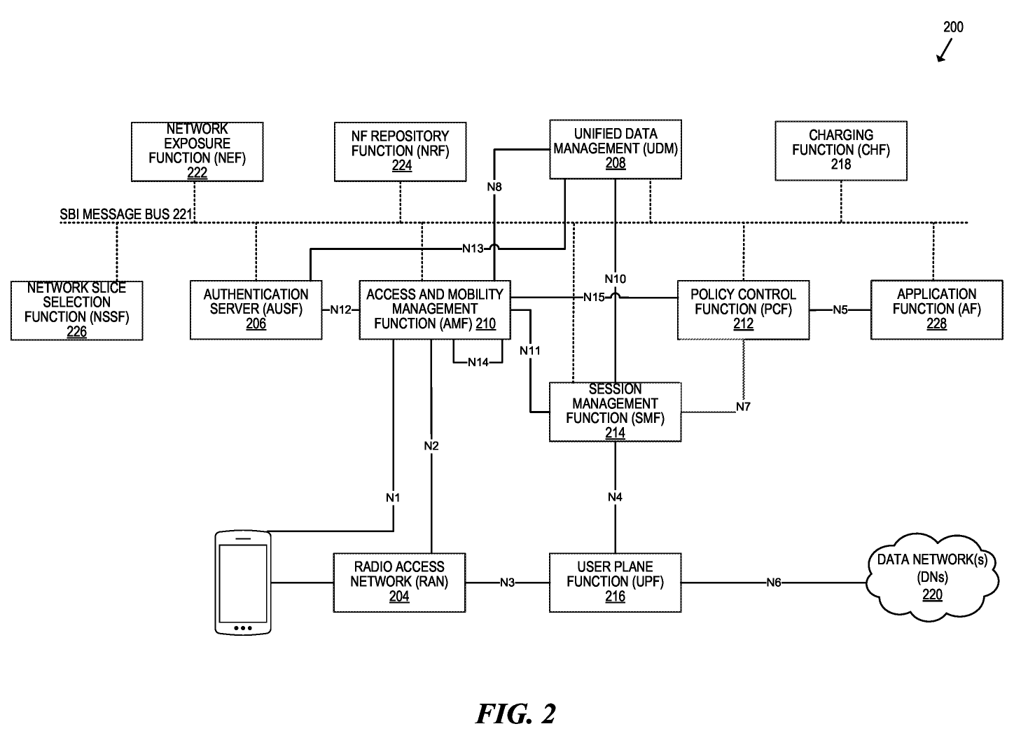

FIG. 2 is a block diagram that illustrates an architecture 200 including 5G core network functions (NFs) that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, a NF Repository Function (NRF) 224 a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, service-level agreements, and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS), to provide authentication credentials while being employed by the AMF 210 and SMF 214 to retrieve subscriber data and context.

The PCF 212 can connect with one or more application functions (AFs) 228. The PCF 212 supports a unified policy framework within the 5G infrastructure for governing network behavior. The PCF 212 accesses the subscription information required to make policy decisions from the UDM 208, and then provides the appropriate policy rules to the control plane functions so that they can enforce them. The SCP (not shown) provides a highly distributed multi-access edge compute cloud environment and a single point of entry for a cluster of network functions, once they have been successfully discovered by the NRF 224. This allows the SCP to become the delegated discovery point in a datacenter, offloading the NRF 224 from distributed service meshes that make-up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224, use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework which, along with the more typical QoS and charging rules, includes Network Slice selection, which is regulated by the NSSF 226.

### Prevention of Brute Force Attacks on Voicemail Accounts

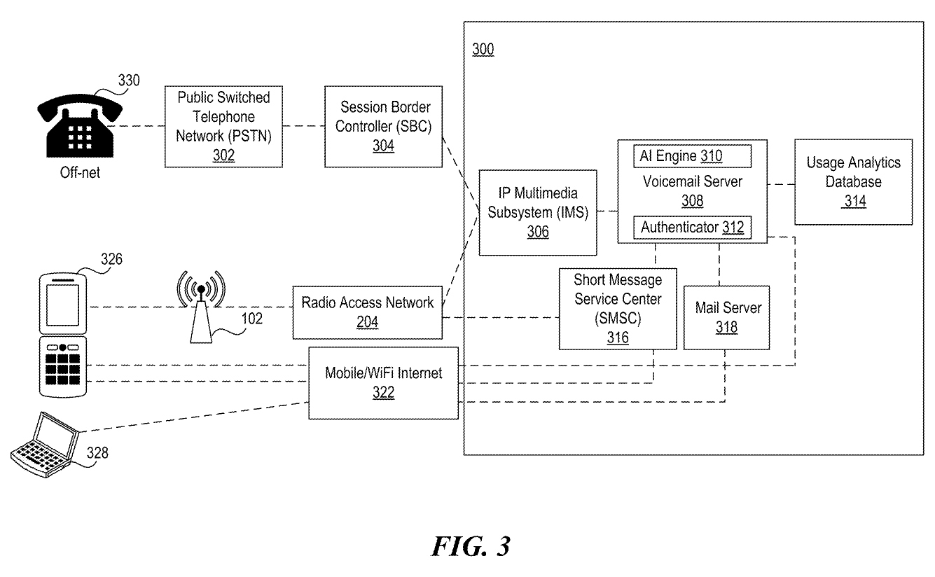

FIG. 3 is a block diagram that illustrates a system 300 for preventing brute force attacks on voicemail accounts. The system 300 can be associated with a wireless telecommunications network (e.g., the network 100 in FIG. 1). The system 300 can be in communication with, or be part of, the architecture 200 in FIG. 2. The system 300 includes a voicemail server 308 (e.g., a server device or a server system), an Internet Protocol (IP) multimedia subsystem (IMS) 306, a short message service center (SMSC) 316, a mail server 318, and a usage analytics database (or data storage) 314. The voicemail server 308 includes, or is in communication with, an artificial intelligence (AI) engine 310 and an authenticator 312. The system 300 is in communication with wireless and non-wireless networks. For example, the system 300 can communicate with user devices (e.g., user devices 326 and 328) via wireless network (e.g., via the RAN 204 and base stations 102) and/or mobile or Wi-Fi internet (e.g., Mobile/Wi-Fi Internet 322). The system 300 can be further in communication with networks other than the network 100 (e.g., off-networks) via a session border controller (SBC) 304. For example, an off-net device 330 of a public switched telephone network (PSTN) 302 can communicate with the system 300 via the SBC 304.

The voicemail server 308 manages and stores voicemail messages and voicemail accounts for users within a telecommunications network. The users can be subscribers who have subscribed to a voicemail service provided by the telecommunications network either as individuals or as part of an organization. For example, a subscriber can be employed by an organization that has purchased a service from the voicemail service provider and the subscriber has a voicemail account associated with his or her work phone. The voicemail server 308 can be configured to record messages left by callers and store them in a digital format, allowing users to access their messages at any time. The voicemail server 308 can provide various interfaces for message retrieval, such as phone systems, web portals, or email, and can notify users of new messages via email, short message service (SMS), or other methods. The voicemail server 308 can manage user accounts, including voicemail boxes, passwords (e.g., personal identification numbers (PINs)), and access permissions, ensuring that only authorized users can access the stored messages. Additionally, the voicemail server 308 can integrate with other communication systems, such as email servers (e.g., the mail server 318), unified messaging systems (e.g., the SMSC 316), and customer relationship management (CRM) systems. The voicemail server 308 can facilitate the secure storing of voicemails and regulate access to voicemail accounts, allowing only authorized users to access such accounts. In particular, the voicemail server 308 can be configured to prevent unauthorized access to voicemail accounts.

In some implementations, the voicemail server 308 includes, or be in communication with, the AI engine 310. The voicemail server 308 can be configured to provide predictions using a user’s prior behavior or other information associated with whether an attempt to access the user’s voicemail account is from an unauthorized party (e.g., an attack such as a brute force attack). The voicemail server 308 can include or be in communication with the usage analytics database 314, which can include analytics data associated with voicemail accounts and/or voicemail users. The AI engine 310 can use the analytics data from the usage analytics database 314 to create the predictions. The voicemail server 308 can also include or be in communication with the authenticator 312. The authenticator 312 can be configured to verify the identity of users attempting to access their voicemail accounts. The authentication can include requiring credentials such as a PIN, a password, a biometric feature (e.g., facial recognition, voice recognition, fingerprint recognition, and/or iris recognition) or other authentication credential. The authentication can allow only authorized users to listen to, delete, or manage voicemail messages, thereby maintaining the security and privacy of the voicemail account.

The SMSC 316 is configured to route, store, and forward SMS messages in a telecommunications network. The SMSC 316 can facilitate delivery of messages to user devices (e.g., the user device 326) and provide SMS-related functionalities such as message retry, delivery confirmation and reporting, and message storage (e.g., when a user device is unavailable to receive a message). The mail server 318 is configured to manage the sending, receiving, and storing of email messages for users within the network (e.g., sending messages to the user device 328). The mail server 318 can facilitate secure email delivery, provide access to stored emails, and support functionalities such as spam filtering, user authentication, and mailbox management. The voicemail server 308 can communicate with the mail server 318 and the SMSC 316, for example, to forward voicemail messages as email attachments and SMS messages, allowing users to access their voicemails through their email inboxes or SMS applications. The voicemail server 308 can also send notifications and alerts related to received voicemails or activity on the voicemail account via the SMSC 316 to user devices to alert users of new voicemail messages and ensuring timely message retrieval.

The voicemail server 308 is also in communication with the IMS 306. The IMS 306 is configured to manage IP-based multimedia services, such as voice, video, and messaging, across both wireless (e.g., the RAN 204) and non-wireless networks (e.g., the PSTN 302). The IMS 306 can facilitate communication between the voicemail server 308 and the wireless and non-wireless networks. The SBC 304 manages and secures the origination, conduct, and termination of voice and multimedia communication sessions (e.g., voice calls). The PSTN 302 includes a global network of circuit-switched telephone systems providing landline telephone services that enable voice communication via a series of interconnected switches and transmission lines.

In FIG. 3, the user device 326 can be a device associated with a subscriber of a voicemail service provided by the network service provider and managed by the voicemail server 308. The user device 326 is associated with an MSISDN (e.g., a phone number) that is identified by the voicemail server 308 as being associated with the subscriber. The user device 328 can also be associated with the subscriber but is associated with a different MSISDN. The off-net device 330, on the other hand, is a device not associated with the subscriber or is a device that the voicemail server 308 does not recognize as being associated with the subscriber. Therefore, voice calls attempting to access a voicemail account associated with the subscriber originating from the off-net device 330 can be suspect as attempted attacks or scams.

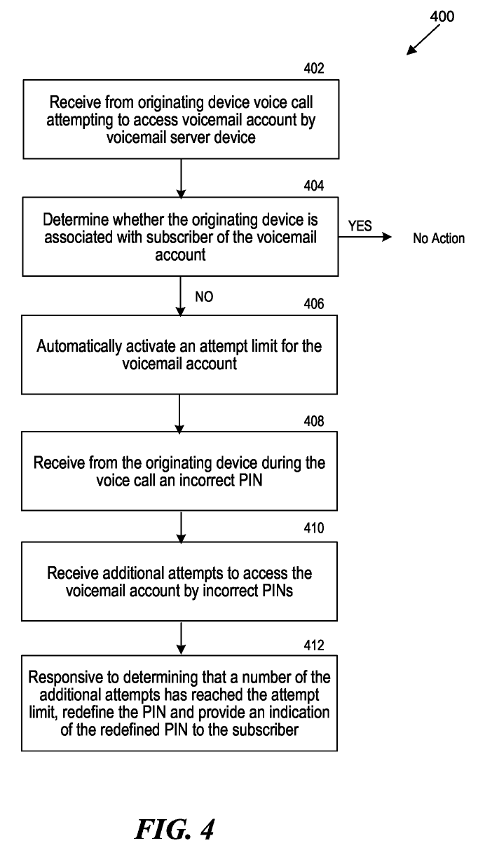

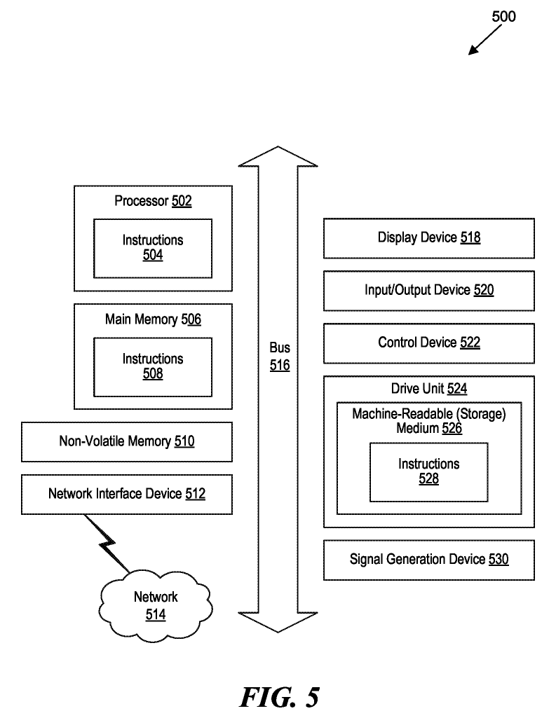

FIG. 4 is a flow diagram that illustrates processes 400 for preventing brute force attacks on voicemail accounts. The processes 400 can be performed by a system (e.g., the system 300 in FIG. 3) associated with a telecommunications network (e.g., the network 100 in FIG. 1). The system can include a voicemail server device (e.g., the voicemail server 308 in FIG. 3). The system can include at least one hardware processor and at least one non-transitory memory storing instructions (e.g., a computer system 500 described with respect to FIG. 5). When the instructions are executed by the at least one hardware processor, the server performs the processes 400.

At 402, the voicemail server device can receive a voice call attempting to access a voicemail account by a voicemail server device associated with a network service provider. The voicemail account can be associated with a subscriber of the network service provider. The voice call can be originated from an originating device associated with an originating mobile station international subscriber directory number (MSISDN). Accessing the voicemail account can require providing a personal identification number (PIN) predefined for the voicemail account by the originating device. Alternatively, accessing the voicemail account can require providing a password (e.g., a password including letters, numbers, and/or special characters). The PIN or password can be defined by the subscriber, for example, as part of setting up the voicemail account. In an instance that the subscriber has not defined the PIN or password, the PIN or password can be provided by the voicemail server device.

At 404, the voicemail server device can determine whether the originating device is associated with the subscriber by determining whether the originating MSISDN corresponds to an MSISDN associated with the subscriber’s device. If the originating MSISDN corresponds to the MSISDN associated with the subscriber’s device, and therefore associated with the voicemail account, the voicemail server device can determine that there is a likelihood that the attempt to access the voicemail account is by the subscriber and not by an unauthorized party. Thereby, responsive to determining that the originating device is associated with the subscriber, the voicemail server device may take no action with respect to protecting the voicemail account (e.g., by activating an attempt limit described at 406). Instead, the voicemail server device can allow access to the voicemail account when a correct PIN is provided and forgo activating the attempt limit.

At 406, responsive to determining that the originating device is not associated with the subscriber, the voicemail server device can automatically activate an attempt limit for the voicemail account. In the scenario of FIG. 3, the originating device is different from the device 326 which is associated with the subscriber (e.g., the originating device is the off-net device 330 or an on-net device other than the device 326). The attempt limit can correspond to a predefined number of failed attempts (e.g., three, five, seven, ten failed attempts) to access the voicemail account by providing an incorrect PIN. The attempt limit can provide additional protection against unauthorized attempts and in particular against brute force attacks. In an instance of a brute force attack, malicious actors systematically attempt combinations of passwords or PINs to gain unauthorized access to voicemail systems. The combinations can be generated with computer algorithms in a short period of time such that tens or hundreds of attempts can be made in a minute, two minutes, five minutes, or ten minutes. These attacks often exploit weak or default passwords. The weak PINs and passwords can include or correspond to, e.g., the subscriber's birthday, name, family member names or birthdays, or easily remembered combinations (e.g., 1234 or ABCD). The default PINs and passwords can include PINs and passwords commonly set for all users (e.g., 0000).

At 408, the voicemail server device can receive from the originating device during the voice call an incorrect PIN that is different from the PIN predefined for the voicemail account. The voicemail server would consider this to be a first failed attempt that counts toward the attempt limit. At 410, the voicemail server device can receive additional attempts to access the voicemail account by incorrect PINs. These additional attempts would further count toward the attempt limit.

At 412, responsive to determining that a number of the incorrect attempts including the additional attempts has reached the attempt limit, the voicemail server device can automatically redefine the PIN and provide an indication of the redefined PIN to the subscriber. For example, the attempt limit can be set to 5 attempts and the attempt limit is reached when the voicemail server device has received the incorrect PIN during the voice call and four additional attempts. In some implementations, the additional attempts are received during the voice call. Alternatively, in some implementations, the additional attempts are received during additional voice calls from one or more additional originating devices. The one or more additional originating devices can be associated with respective MSISDNs that are different from the originating MSISDN.

For example, the additional attempts can be received during the voice call or they can be received during one or more additional voice calls that are originating from the originating device or any other devices. In some implementations, the attempt limit needs to be reached within a pre-defined time period (e.g., a time period ranging from a minute to an hour). In response to reaching the attempt limit, the voicemail server device can redefine the PIN or the password and provide the indication to the subscriber. In some implementations, the indication of the redefined PIN includes a link for redefining the PIN using a voicemail administration access portal associated with the voicemail server (e.g., an administration access portal associated with the voicemail server device 308 in FIG. 3).

In some implementations, the voicemail server device providing the indication of the redefined PIN to the subscriber includes transmitting a short message to an MSISDN associated with the subscriber via a short message service (SMS) (e.g., an SMS via the SMSC 316 in FIG. 3 is transmitted to the device 326). The short message can include the redefined PIN or password.

In some implementations, providing the indication of the redefined PIN to the subscriber includes transmitting a biometrics-protected short message to an MSISDN associated with the subscriber via the SMS. The biometrics-protected short message can require the subscriber to provide one or two forms of biometric identification prior to providing the subscriber with the indication of the redefined PIN. Biometric identification can include facial recognition, voice recognition, fingerprint recognition, iris recognition, or a combination thereof. In some implementations, biometric identification is used in combination with requesting the PIN or the password.

In some implementations, providing the indication of the redefined PIN to the subscriber includes transmitting an email message to an email address associated with the subscriber (e.g., an email is transmitted via the mail server 318 to the device 328 in FIG. 3). The email message includes the redefined PIN or password. In some implementations, the device 328 is a device associated with the subscriber that is different from the device 326 and therefore associated with a different MSISDN than the device 326. For example, the device 328 can be a personal computer device or a computer device associated with an organization and used by the subscriber (e.g., a work computer). The email can be sent to the subscriber’s private email that is included in the subscriber’s voicemail account profile, or to an organizational email (e.g., the subscriber’s work email).

In some implementations, providing the indication of the redefined PIN to the subscriber includes causing an authenticator mobile application on the subscriber’s device to provide a notification indicating that the PIN is redefined. The authenticator mobile application can be operated by a third-party different from the system 300. The voicemail server device can cause the authenticator mobile application to request a two-factor authentication from the subscriber prior to providing the redefined PIN to the subscriber. The two-factor authentication can include two of a PIN, a password, and a biometric (e.g., a PIN and voice recognition, or a voice and fingerprint recognition).

In some implementations, the attempt limit corresponds to a first number of failed attempts when the incorrect PINs are provided during the voice call and the attempt limit corresponds to a second number of failed attempts when the incorrect PINs are provided during multiple voice calls received within a period of time. The first number and the second number can be different from each other.

In some implementations, responsive to determining that the originating device is not associated with the subscriber and before the number of the additional attempts has reached the attempt limit, the voicemail server device can determine whether the originating MSISDN is associated with an on-network MSISDN or an off-network MSISDN (e.g., the device 330 in FIG. 3 is an off-net device associated with an off-network MSISDN). The determination includes determining whether the originating MSISDN is within a range of MSISDNs associated with the network service provider. Responsive to determining that the originating MSISDN is associated with an off-network MSISDN, the voicemail server device can determine the geographical location of the subscriber’s device and determine a geographical area associated with the off-network MSISDN. The voicemail server device can determine whether the geographical area associated with the off-network MSISDN includes the geographical location of the subscriber’s device. In an instance that the geographical area associated with the off-network MSISDN does not include the geographical location of the subscriber’s device, the voicemail server device can redefine the PIN and provide the indication of the redefined PIN to the subscriber.

The geographical location can be an indication of whether the voice call originated from the off-network device could be made by the subscriber. For example, if it is known that the subscriber lives in a particular area (e.g., a city or a state) and the off-network device is located in that particular area, a determination can be made that there is a likelihood that the voice call is made by the subscriber. If the off-network device is located outside the particular (e.g., in a different country or state), a determination can be made that there is a likelihood that the voice call is not made by the subscriber. In particular, voice calls originating from foreign countries can be considered a high suspect for cyber attacks.

In some implementations, responsive to determining that the originating device is not associated with the subscriber, the voicemail server device obtains behavioral analytical data associated with the subscriber (e.g., stored in the usage analytics database 314). The voicemail server device can predict, based on the behavioral analytical data using a machine learning model, whether the voice call is originated by the subscriber while the subscriber is located outside the network associated with the network service provider.

A "model," as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine learning model can be a neural network with multiple input nodes that receive behavioral analytical data including. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, ("the output layer") one or more nodes can produce a value classifying the input that, once the model is trained, can be used to predict or provide a probability for whether a voice call is originated by the subscriber. In some implementations, such neural networks, known as deep neural networks, can have multiple layers of intermediate nodes with different configurations, can be a combination of models that receive different parts of the input and/or input from other parts of the deep neural network, or are convolutions - partially using output from previous iterations of applying the model as further input to produce results for the current input.

A machine learning model can be trained with supervised learning, where the training data includes historical behavioral data associated with a subscriber as input and a desired output, such as a determination that a voice call was originated by the subscriber. The historical behavioral data can include features, for example, geographical locations (e.g., where the subscriber is located when making voice calls) , time of day and day of the week making voice calls, time of day for accessing voicemail account, frequency of accessing voicemail account, and other behavioral features. Output from the model can be compared to the desired output and, based on the comparison, the model can be modified, such as by changing weights between nodes of the neural network or parameters of the functions used at each node in the neural network (e.g., applying a loss function). After applying each of the features the training data and modifying the model in this manner, the model can be trained to evaluate new predictions on whether a voice call is originated by the subscriber.

Based on a prediction that the voice call is not originated by the subscriber (e.g., a likelihood that the failed attempts are originated by the subscriber is predicted to be below a threshold level of likelihood), the voicemail server device can automatically set the voicemail account on hold and provide an indication of the hold to the subscriber. Setting the voicemail account on hold can refer to, for example, that the voicemail account cannot be accesses unless a correct PIN, password, biometric identifier and/or other authentication is provided. However, setting the voicemail account does not necessarily require that the PIN or password is redefined. In some implementations, based on a prediction that the voice call is not originated by the subscriber, the voicemail server can redefine the PIN as described at 412. In contrast, based on a prediction that the voice call is originated by the subscriber (e.g., a likelihood that the failed attempts are originated by the subscriber is predicted to be above a threshold level of likelihood), the voicemail server device can forgo automatically setting the voicemail account on hold or redefining the PIN.

In some implementations, the machine learning model is trained based on historical behavioral data associated with the subscriber and/or profile information associated with the voicemail account. The historical behavioral data can include geographical locations where the subscriber has previously been located at (e.g., made phone calls from), time of day associated with the subscriber’s activities (e.g., the subscriber makes phone calls during business hours in Pacific Time Zone), whether the subscriber generally uses a single device (e.g., the device 326) to call the voicemail server device or whether the subscriber has a tendency to use multiple devices. The behavioral analytical data and the machine learning algorithm are used to avoid redefining the PIN in instances where the failed attempts to access the voicemail are actually made by the subscriber. The prediction can avoid causing unnecessary disruption to the subscriber of the voicemail account.

In some implementations, the behavioral analytical data includes geographical locations of user devices the subscriber has previously used to access the voicemail account. As an example, the behavioral analytical data can include historical locations that the subscriber is associated with including hometown or state, places the subscriber travels to, or places the subscriber calls to. A subscriber can be a mountain climber having a history of traveling to geographical areas with mountains. If the voice call is originated from a geographical area with mountains, the voicemail server device can determine that there is a likelihood that the voice call is by the subscriber. As another example, the behavioral analytical data can include historical locations that the subscriber regularly calls a foreign country (e.g., has family in the foreign country). If the voice call is originated from that foreign country, the voicemail server device can determine that there is a likelihood that the voice call is by the subscriber who is visiting the foreign country (e.g., to see family).

In some implementations, the voicemail account can be uninitialized. Initializing a voicemail account can include, for example, dialing a number provided by the voicemail server device, entering a default password, and setting up a personal greeting and the PIN or password. An uninitialized voicemail account refers therefore to a voicemail account that has, for example, the default password (e.g., the subscriber has not set the PIN). In instances of uninitialized voicemail accounts, the voicemail server device can deny access to the voicemail by voice calls originating from any other MSISDN than the MSISDN associated with the subscriber (e.g., regardless of the prediction made based on the user behavioral analytics).

In some implementation, the voicemail server device receives a voice call from an originating device attempting to access a voicemail account associated with a subscriber of the network service provider, as described at 402. Accessing the voicemail account can require providing by the originating device a PIN predefined for the voicemail account. The voicemail server device can be caused to determine whether the originating device is an on-network device associated with the network service provider. For example, a device having an MSISDN within a range of MSISDNs is determined to be associated with the network service provider while a device having an MSISDN outside the range of MSISDNs of the network service provider is determined as an off-network device (e.g., the device 330 in FIG. 3). Responsive to determining that the originating device is not associated with the network service provider, the voicemail server device can be caused to activate an attempt limit for the voicemail account, as described at 406. The attempt limit can correspond to a predefined number of failed attempts to access the voicemail account by providing an incorrect PIN. The voicemail server device can be caused to receive attempts to access the voicemail account by incorrect PINs. Responsive to determining that a number of the attempts has reached the attempt limit, the voicemail server device can be caused to redefine the PIN.

### Computer System

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A computer-implemented method for preventing brute force attacks on a voicemail account associated with a telecommunications network service provider, the method comprising:
receiving, by a voicemail server device associated with the network service provider, a voice call attempting to access a voicemail account associated with a subscriber of the network service provider,
wherein the voice call is originated from an originating device associated with an originating mobile station international subscriber directory number (MSISDN), and
wherein accessing the voicemail account requires providing, by the originating device, a personal identification number (PIN) predefined for the voicemail account;
determining, by the voicemail server device, whether the originating device is associated with the subscriber by determining whether the originating MSISDN corresponds to an MSISDN associated with a device of the subscriber;
responsive to determining that the originating device is not associated with the subscriber:
automatically activating, by the voicemail server device, an attempt limit for the voicemail account,
wherein the attempt limit corresponds to a predefined number of failed attempts to access the voicemail account by providing an incorrect PIN;
receiving, by the voicemail server device from the originating device during the voice call, an incorrect PIN that is different from the PIN predefined for the voicemail account;
receiving, by the voicemail server device, additional attempts to access the voicemail account by incorrect PINs; and
responsive to determining that a number of the additional attempts has reached the attempt limit,
automatically redefining, by the voicemail server device, the PIN and providing an indication of the redefined PIN to the subscriber.

2. The method of claim 1,
wherein providing the indication of the redefined PIN to the subscriber comprises:
transmitting, by the voicemail server device via a short message server (SMS), a short message to an MSISDN associated with the subscriber,
wherein the short message includes the redefined PIN.

3. The method of claim 1,
wherein providing the indication of the redefined PIN to the subscriber comprises:
transmitting, by the voicemail server device via a short message server (SMS), a biometrics protected short message to an MSISDN associated with the subscriber,
wherein the biometrics protected short message requires the subscriber to provide one or two biometric identification prior to providing the subscriber with the indication of the redefined PIN.

4. The method of claim 1,
wherein providing the indication of the redefined PIN to the subscriber comprises:
transmitting, by the voicemail server device, an email message to an email address associated with the subscriber,
wherein the email message includes the redefined PIN.

5. The method of claim 1,
wherein providing the indication of the redefined PIN to the subscriber comprises:
causing, by the voicemail server device, an authenticator mobile application on the subscriber’s device to provide a notification indicating that the PIN is redefined, and
causing the authenticator mobile application to request a two-factor authentication from the subscriber prior to providing the predefined PIN to the subscriber.

6. The method of claim 1,
wherein the indication of the redefined PIN includes a link for redefining the PIN using a voicemail administration access portal associated with the voicemail server device.

7. The method of claim 1,
wherein the attempt limit corresponds to a first number of failed attempts when the incorrect PINs are provided during the voice call, and
wherein the attempt limit corresponds to a second number of failed attempts when the incorrect PINs are provided during multiple voice calls received within a period of time.

8. The method of claim 1, further comprising:
responsive to determining that the originating device is associated with the subscriber, allowing access to the voicemail account and forgoing activating the attempt limit.

9. The method of claim 1, further comprising:
responsive to determining that the originating device is not associated with the subscriber and before the number of the additional attempts has reached the attempt limit:
determining whether the originating MSISDN is associated with an on-network MSISDN or an off-network MSISDN by determining whether the originating MSISDN is within a range of MSISDNs associated with the network service provider;
responsive to determining that the originating MSISDN is associated with an off-network MSISDN:
determining a geographical location of the subscriber’s device,
determining a geographical area associated with the off-network MSISDN,
determining whether the geographical area associated with the off-network MSISDN includes the geographical location of the subscriber’s device, and
responsive to determining that the geographical area associated with the off-network MSISDN does not include the geographical location of the subscriber’s device, redefining the PIN and providing the indication of the redefined PIN to the subscriber.

10. The method of claim 1, further comprising:
responsive to determining that the originating device is not associated with the subscriber:
obtaining behavioral analytical data associated with the subscriber;
predicting, based on the behavioral analytical data using a machine learning model, whether the voice call is originated by the subscriber while the subscriber is located outside the network associated with the network service provider; and
based on a prediction that the voice call is not originated by the subscriber, automatically setting the voicemail account on hold and providing an indication of the hold to the subscriber.

11. The method of claim 10,
wherein the machine learning model is trained based on historical behavioral data associated with the subscriber and/or profile information associated with the voicemail account.

12. The method of claim 10,
wherein the behavioral analytical data includes geographical locations of user devices the subscriber has previously used to access the voicemail account.

13. The method of claim 1,
wherein the additional attempts are received during the voice call.

14. The method of claim 1,
wherein the additional attempts are received during additional voice calls from one or more additional originating devices, and
wherein the one or more additional originating devices are associated with respective MSISDNs that are different from the originating MSISDN.

15. A non-transitory, computer-readable storage medium comprising instructions recorded thereon, wherein the instructions, when executed by at least one data processor of a voicemail server device associated with a network service provider, cause the voicemail server device to:
receive a voice call from an originating device attempting to access a voicemail account associated with a subscriber of the network service provider,
wherein accessing the voicemail account requires providing, by the originating device, a personal identification number (PIN) predefined for the voicemail account;
determine whether the originating device is an on-network device associated with the network service provider;
responsive to determining that the originating device is not an on-network device:
activate an attempt limit for the voicemail account,
wherein the attempt limit corresponds to a predefined number of failed attempts to access the voicemail account by providing an incorrect PIN;
receive attempts to access the voicemail account by incorrect PINs; and
responsive to determining that a number of the attempts has reached the attempt limit, redefine the PIN.

16. The computer-readable storage medium of claim 15,
wherein the originating device is associated with an originating mobile station international subscriber directory number (MSISDN), and
wherein determining whether the originating device is associated with the network service provider includes determining whether the originating MSISDN is within a range of MSISDNs associated with the network service provider.

17. The computer-readable storage medium of claim 15, wherein the voicemail server device is further caused to:
provide an indication of the redefined PIN to the subscriber by transmitting, via short message service (SMS), a short message to an MSISDN associated with the subscriber,
wherein the short message includes the redefined PIN.

18. The computer-readable storage medium of claim 15, wherein the voicemail server device is further caused to:
provide an indication of the redefined PIN to the subscriber by transmitting, via a short message server (SMS), a biometrics protected short message to an MSISDN associated with the subscriber,
wherein the biometrics protected short message requires the subscriber to provide one or two biometric identification prior to providing the subscriber with an indication of the redefined PIN.

19. A server device associated with a telecommunications network service provider, the server device comprising:
at least one hardware processor, and
at least one non-transitory memory storing instructions, which, when executed by the at least one hardware processor, cause the server device to:
receive a voice call from an originating device attempting to access a voicemail account associated with a subscriber of the network service provider,
wherein accessing the voicemail account requires providing, by the originating device, a personal identification number (PIN) predefined for the voicemail account;
determine whether the originating device is associated with the subscriber;
responsive to determining that the originating device is not associated with the subscriber:
activate an attempt limit for the voicemail account,
wherein the attempt limit corresponds to a predefined number of failed attempts to access the voicemail account by providing an incorrect PIN;
receive attempts to access the voicemail account by incorrect PINs; and
responsive to determining that a number of the attempts has reached the attempt limit,
redefine the PIN.

20. The server device of claim 19,
wherein the originating device is associated with an originating mobile station international subscriber directory number (MSISDN), and
wherein determining whether the originating device is associated with the subscriber includes determining whether the originating MSISDN corresponds to an MSISDN associated with a device of the subscriber.
